(19) United States
(12) Patent Application Publication
(10) Pub. No.: US 2024/0347753 A1
(43) Pub. Date: Oct. 17, 2024

(54) DEVICE FOR FORMING SHARK FIN OF 3-SIDED SEALING POUCH TYPE SECONDARY BATTERY

(71) Applicant: CLEVER CO., LTD., Chungcheongbuk-do (KR)

(72) Inventors: Jong Hong JEONG, Chungcheongbuk-do (KR); Sang Jin KIM, Daejeon Metropolitan City (KR)

(21) Appl. No.: 18/682,553

(22) PCT Filed: Aug. 10, 2022
(86) PCT No.: PCT/KR2022/011902

§ 371 Date: Feb. 9, 2024

(30) Foreign Application Priority Data
Aug. 13, 2021 (KR) 10-2021-0107643

(51) Int. Cl. H01M 10/04; H01M 50/105

(52) U.S. Cl. CPC H01M 10/0404; H01M 50/105

(57) ABSTRACT

The disclosed device for forming a shark fin of a 3-sided sealing pouch type secondary battery includes: lower props being in contact with a lower surface of a terrace connected to shark fins formed at a front end and a rear end of a sealed surface of a 3-sided sealing pouch type secondary battery; upper props being in contact with an upper surface of the terrace connected to the shark fins; and folding bars folding the shark fins exposed to the outside of the terrace gripped by the lower prop and the upper prop, and heating elements are installed inside the folding bars, the folding bars fold the shark fins upwards while moving up below the shark fins.

### TECHNICAL FIELD

The present invention relates to a device for forming a shark fin of a 3-sided sealing pouch type secondary battery, and particularly, to a device for forming a shark fin of a 3-sided sealing pouch type secondary battery which can fold a shark fin based on a folding line formed in shark fins of the 3-sided sealing pouch type secondary battery.

### BACKGROUND ART

This section provides background information related to the present invention which is not necessarily prior art.

Secondary batteries are widely used as a power source for mobile devices such as mobile phones and laptops. In particular, the use of lithium secondary batteries is rapidly increasing due to the advantages of high operating voltage and high energy density per unit weight.

These lithium secondary batteries mainly use lithium-based oxide as a positive electrode active material and carbon material as a negative electrode active material, and depending on the type of electrolyte, the lithium secondary batteries may be classified into lithium-ion batteries, lithium-ion polymer batteries, and lithium polymer batteries, and depending on an outer shape of the battery, the lithium secondary batteries may be classified into cylindrical, prismatic, and pouch type secondary batteries.

Representatively, in terms of battery shape, there is high demand for the prismatic secondary batteries and the pouch type secondary batteries that can be applied to products due to a thin thickness thereof.

In particular, an interest in the pouch type secondary batteries is concentrated because pouch type secondary batteries have no restrictions on shape and size, are easy to assemble through heat fusion, and easily effectively expel gas or liquid when abnormal behavior occurs, making them suitable for manufacturing lightweight and thin thickness cells.

Generally, the pouch type secondary battery has a structure in which an electrode assembly is installed inside a pouch exterior material made of an aluminum laminate sheet. That is, the pouch type secondary battery forms an accommodating part for mounting the electrode assembly on the aluminum laminate sheet, and with the electrode assembly mounted on the accommodating part, a separate aluminum laminate sheet or an extended aluminum laminate sheet is separated from the aluminum laminate sheet is thermally fused and manufactured.

Meanwhile, in the detachable pouch exterior material, two aluminum laminate sheets are combined by overlapping and sealing each other, so during the manufacturing process of the secondary battery, the accommodation parts on both sides must be overlapped in the correct position with the electrode assembly built in. In addition, since two units of aluminum laminate sheets are joined on four sides to form a sealing portion, all four sealed surfaces come into contact with the atmosphere, which greatly increases the possibility of air entering during long-term use, thereby shortening the lifespan of the battery.

To solve this problem, techniques have been introduced for forming two corresponding accommodation parts on one aluminum laminate sheet, overlapping them, and sealing the three sides.

FIG. 1 is a diagram illustrating a 3-sided sealing pouch type secondary battery related to the present invention, and the three-side sealing pouch type secondary battery 10 is manufactured by forming two accommodation parts 14 having shapes and sizes perfectly corresponding on one pouch laminate sheet 12, bending a central portion between accommodation parts 14, and overlapping the accommodation parts 14 under a state in which an electrode assembly (not illustrated) is mounted on any one accommodation part 14, and sealing three remaining 3 sides other than the bent side.

The 3-sided sealing pouch type secondary battery 10 may maintain a sealed state without a sealing process of combining the pouch laminate sheet 12 to one side 16 (hereinafter, referred to as ‘sealed surface’) among four sides, and a sealing portion (so-called ‘wing’) formed by the sealing process is not generated, so a volume of the pouch type secondary battery 10 is reduced.

As a result, a space where the pouch type secondary battery 10 is accommodated in an electric vehicle is reduced.

However, in the above-mentioned 3-sided sealing pouch type secondary battery 10, while the pouch laminate sheet 12 of the sealed surface 16 on 3 sides is pressed, shark fins 18 are inevitably formed between both ends of the sealed surface 16 and a terrace 20 illustrated in FIG. 1.

The formed shark fin 18 reduces a volume reduction effect of the 3-sided sealing pouch type secondary battery 10. Accordingly, a process for eliminating the increase in volume caused by the shark fin 18 is required.

### DISCLOSURE

### Technical Problem

One object of the present invention is to provide a device for forming a shark fin of a 3-sided sealing pouch type secondary battery which may fold a shark fin based on a folding line formed in shark fins of the 3-sided sealing pouch type secondary battery.

One object of the present invention is to provide a device for forming a shark fin of a 3-sided sealing pouch type secondary battery which may fold the shark fin while ensuring electrical insulation for an adhesive layer.

Further, an object to be achieved by the present invention is not limited to the aforementioned technical objects, and other technical objects, which are not mentioned above, will be apparently appreciated by a person having ordinary skill in the art from the following description.

### Technical Solution

This section provides a general summary of the invention and is not a comprehensive invention of its full scope or all of its features.

In order to solve the problem, a device for forming a shark fin of a 3-sided sealing pouch type secondary battery according to any one aspect of various aspects for describing the present invention includes: lower props being in contact with a lower surface of a terrace connected to shark fins formed at a front end and a rear end of a sealed surface of a 3-sided sealing pouch type secondary battery; upper props being in contact with an upper surface of the terrace connected to the shark fins; and folding bars folding the shark fins exposed to the outside of the terrace gripped by the lower prop and the upper prop, and heating elements may be installed inside the folding bars, the folding bars may fold the shark fins upwards while moving up below the shark fins, and front surfaces of the folding bars contacting the shark fins may be formed as inclination surfaces extended to be inclined downwards to a rear surface of the lower prop from upper surfaces of the folding bars, and the inclination surface and the lower surface of the folding bar may be connected to convex curvature surfaces.

In the device for forming a shark fin of a 3-sided sealing pouch type secondary battery according to any one aspect of various aspects for describing the present invention, a folding line may be provided, which is aligned with the sealed surface, and formed up to an adjacent location of the sealed surface from ends of both terraces facing both ends of the sealed surface, the upper props may be extended in a longitudinal direction of the folding line so as to be parallel to the sealed surface, upper prop tips contacting the upper surfaces of the terrace connected to the folding lines may be formed at lower portions of the upper props, the lower props may be extended in the longitudinal direction of the folding line so as to be parallel to the sealed surface, and lower prop tips contacting the lower surfaces of the terrace connected to the folding lines may be formed at upper portions of the lower props.

In the device for forming a shark fin of a 3-sided sealing pouch type secondary battery according to any one aspect of various aspects for describing the present invention, an edge portion of the lower prop tip may be formed as a curvature surface, and an edge formed when an upper surface of the lower prop tip and a rear surface of the lower prop tip meet may be in contact with a boundary line formed by the folding lines and the lower surface of the terrace, and an edge portion of the upper prop tip may be formed as the curvature surface, and an edge formed when a lower surface of the upper prop tip and a rear surface of the upper prop tip meet may be in contact with a boundary line formed by the folding lines and the upper surface of the terrace.

In the device for forming a shark fin of a 3-sided sealing pouch type secondary battery according to any one aspect of various aspects for describing the present invention, the lower props may be provided to be guided to a folding location jointly with the upper props and the folding bars by actuation of an X-axis transfer means, and be in contact with the lower surface of the terrace connected to the shark fins, and returned by the actuation of the X-axis transfer means jointly with the upper props and the folding bars upon completing folding of the shark fins, and the upper props may be guided to a folding location jointly with the lower props and the folding bars by the actuation of the X-axis transfer means, and moved down by actuation of a Z-axis transfer means and be in contact with the upper surface of the terrace connected to the shark fins, and moved up by the actuation of the Z-axis transfer means upon completing the folding of the shark fins, and returned by the actuation of the X-axis transfer means jointly with the lower props and the folding bars.

In the device for forming a shark fin of a 3-sided sealing pouch type secondary battery according to any one aspect of various aspects for describing the present invention, the folding bars may be disposed on rear surfaces of the lower props, and the folding bars may be provided to have a length corresponding to lengths of the shark fins.

In the device for forming a shark fin of a 3-sided sealing pouch type secondary battery according to any one aspect of various aspects for describing the present invention, the folding bars may be provided to be guided to a folding location jointly with the lower props and the upper props by the actuation of the X-axis transfer means, and fold the shark fins upwards based on the folding lines while being moved up by actuation of another Z-axis transfer means, and moved down by actuation of yet another Z-axis transfer means upon completing the folding of the shark fins and at the same time, returned by the actuation of the X-axis transfer means jointly with the lower props and the upper props.

### Advantageous Effects

According to the present invention, an effect can be provided, which can easily fold the shark fin based on the folding line formed at shark fins of the 3-sided sealing pouch type secondary battery.

According to the present invention, since the shark fin is folded by assigning heat and pressure upon folding the shark fin, the adhesive layer of the shark fin can be melted and flow to a portion where electrical insulation is broken, and as a result, an effect can be provided, which can ensure the electrical insulation for the adhesive layer of the shark fin.

### DESCRIPTION OF DRAWINGS

FIG. 1 is a plan view of a 3-sided sealing pouch type secondary battery related to the present invention.

FIG. 2 is a process diagram schematically illustrating a process in which shark fins of the 3-sided sealing pouch type secondary battery related to the present invention are folded.

FIG. 3 is a plan view of the 3-sided sealing pouch type secondary battery in which a folding line is formed in the shark fin by a folding line forming process illustrated in FIG. 2.

FIG. 4 is a front view enlarging and illustrating a shark fin forming device of the 3-sided sealing pouch type secondary battery according to the present invention illustrated in FIG. 2.

FIG. 5 is a side view of the shark fin forming device of the 3-sided sealing pouch type secondary battery according to the present invention illustrated in FIG. 4.

FIGS. 6, 7 and 8 are diagrams schematically illustrating an operation state of the shark fin forming device of the 3-sided sealing pouch type secondary battery according to the present invention.

### MODES OF THE INVENTION

Hereinafter, an exemplary embodiment of implementing a 3-sided sealing pouch type secondary battery according to the present invention will be described in detail with reference to drawings.

However, it cannot be said that the intrinsic technical spirit of the invention is limited to an exemplary embodiment described below, and it is disclosed that the technical spirit includes a scope which may be easily proposed by a method of substitutions or changes for the exemplary embodiment described below based on the intrinsic technical spirit of the invention by those skilled in the art.

Further, since terms used below are selected for easy description, the terms are not limited to dictionary meanings and should be appropriately interpreted as meanings consistent with the technical spirit of the invention in order to grasp the intrinsic technical spirit of the invention.

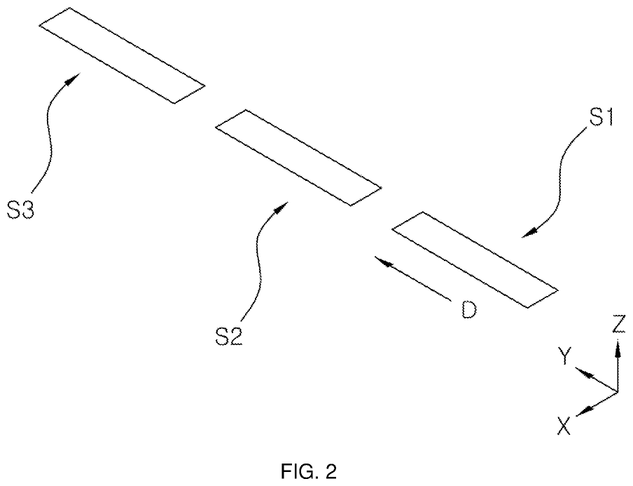

Among the accompanying drawings, FIG. 2 is a process diagram schematically illustrating a process in which shark fins of the 3-sided sealing pouch type secondary battery related to the present invention are folded.

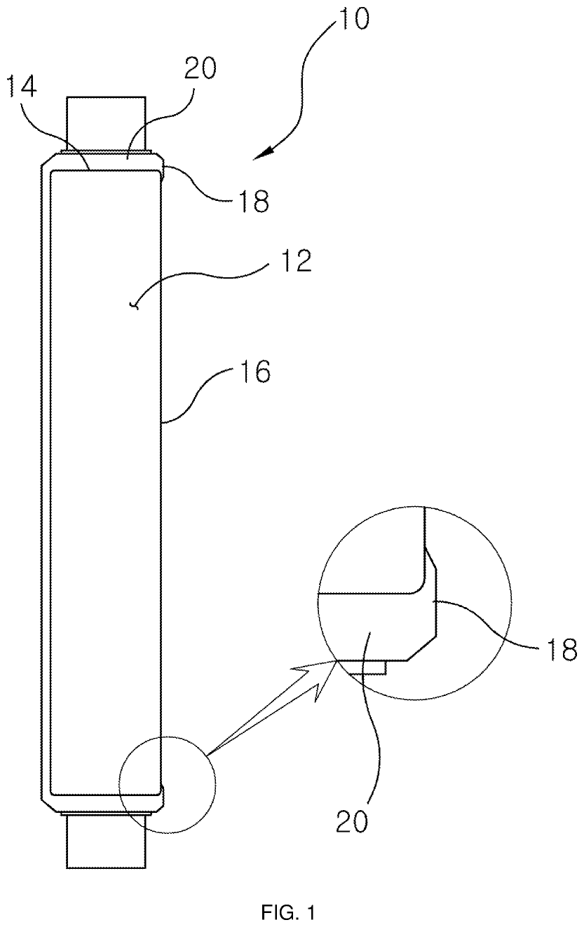

Referring to FIG. 2, both ends of a sealed surface 16 of the 3-sided sealing pouch type secondary battery 10 (see FIG. 1) related to the present invention, and shark fins 18 formed in both terraces 20 connected to both ends of the sealed surface 16 are folded in a predetermined shape while sequentially going through a folding line forming process S1, a folding process S2, and a heating press process S3.

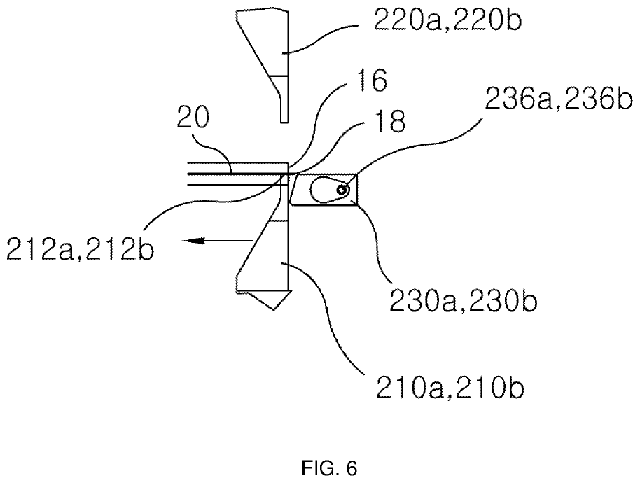

The folding line forming process S1 is a process of forming folding lines L (see FIG. 6) which are folding reference lines between the terraces 20 and the shark fins 18 formed at both ends of the sealed surface 16, the folding process S2 is a process of folding the shark fin 18 upwards based on the folding line L, and the heating press process S3 is a process of completing shapes of the folded shark fins 18 so that the folded shark fins 18 are not restored to an original shape.

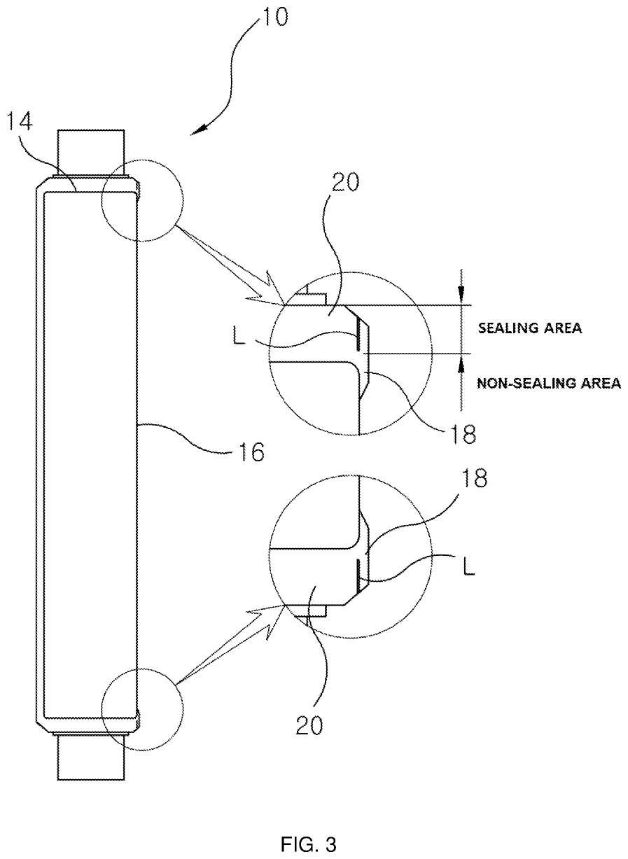

Here, when the 3-sided sealing pouch type secondary battery 10 is viewed from the top as illustrated in FIG. 3, the folding lines L formed in the folding line forming process S1 are formed to be aligned with the sealed surface 16 from ends of both terraces 20 facing both ends of the sealed surface 16 up to a location adjacent to an accommodation part 14 (main room), and the folding lines L are formed to have lengths corresponding to sealing areas of both terraces 20, and the folding lines L and the accommodation part 14 (main room) are formed to maintain an interval of 1 mm or more.

Preferably, the shark fins 18 are folded to form the substantially same plane as the sealed surface 16.

More preferably, after the heating press process S3, a cooling process of cooling the shark fin 18 heated in the heating press process S3 may be further included.

Meanwhile, devices that perform the folding line forming process S1, the folding process S2, and the heating press process S3 are installed in line at one side of a process progress path D as illustrated.

In addition, for folding the shark fins 18, the 3-sided sealing pouch type secondary battery 10 is vacuum-adsorbed on a cell transfer shuttle (not illustrated) while the sealed surface 16 is laid down to face one side of the process progress path D, and the 3-sided sealing pouch type secondary battery 10 mounted on the cell transfer shuttle sequentially goes through the folding line forming process S1, the folding process S2, and the heating press process S3 by actuation of the cell transfer shuttle.

Here, the process progress path D which is formed in a Y-axis direction (see FIG. 2) as illustrated, means a path in which the 3-sided sealing pouch type secondary battery 10 is mounted on the cell transfer shuttle, and transferred for folding the shark fins 18.

A shark fin forming device 200 of the 3-sided sealing pouch type secondary battery 10 according to the present invention as a device that performs the folding process S2 among the above-mentioned processes folds shark fins 18 formed at a front end and a rear end of the 3-sided sealing pouch type secondary battery 10 mounted on the cell transfer shuttle and guided based on the folding lines L in the folding line forming process S1.

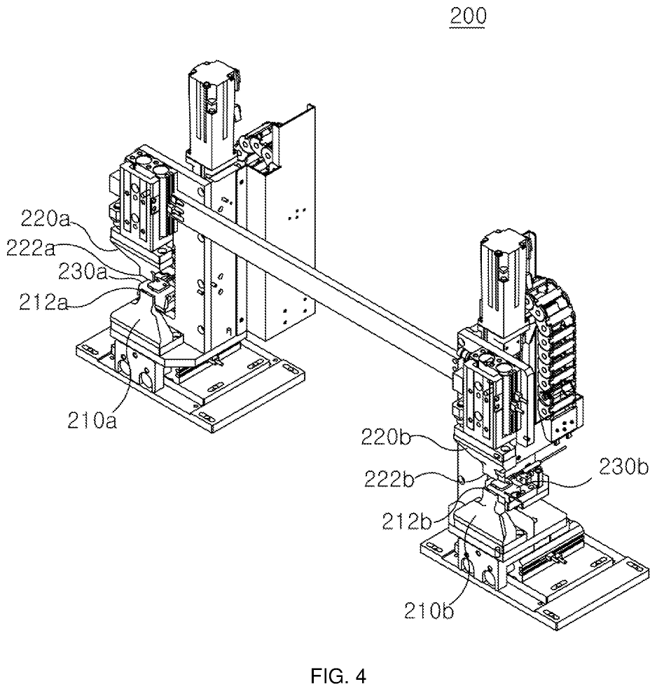

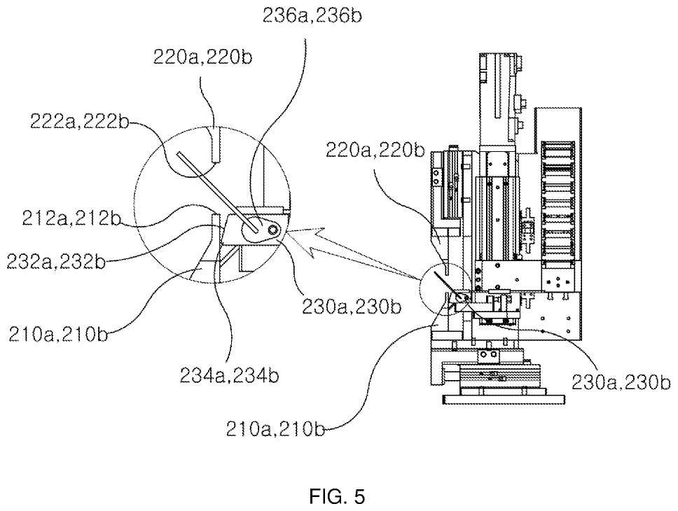

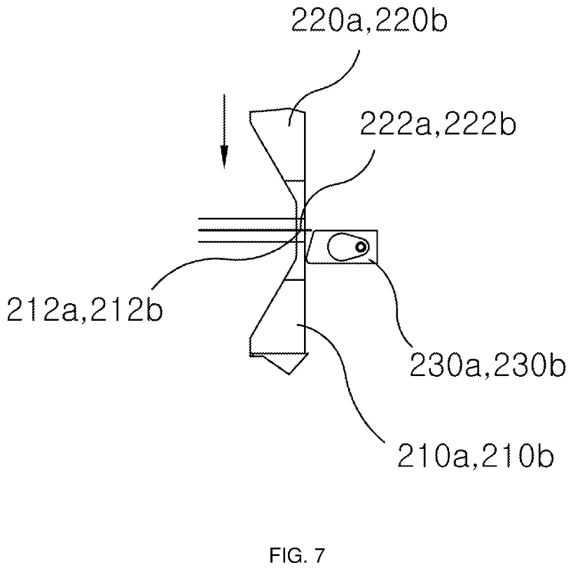

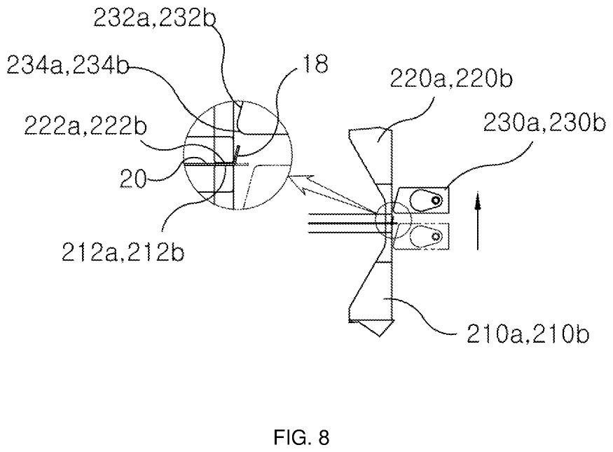

Among the accompanying drawings, FIGS. 4 to 8 are diagrams illustrating the shark fin forming device of the 3-sided sealing pouch type secondary battery according to the present invention.

Referring to FIGS. 4 to 6, the shark fin forming device 200 of the 3-sided sealing pouch type secondary battery according to the present invention includes lower props 210a and 210b, upper props 220a and 220b, and folding bars 230a and 230b.

First, the lower props 210a and 210b contact the lower surface of the terrace 20 connected to the shark fins 18, preferably the lower surface of the terrace 20 connected to the folding lines L, to grip the terrace 20 so as not to interfere with the folding line L jointly with the upper props 220a and 220b.

The lower props 210a and 210b are provided as a pair to face the shark fins 18 formed on the front and rear ends of the sealing surface 16 and the accommodation part 14 (main room) of the 3-sided sealing pouch type secondary battery 10, respectively.

The lower props 210a and 210b are provided in an approximately vertical plate shape extending along the longitudinal direction of the folding line L, and lower prop tips 212a and 212b contacting a boundary line formed by the lower surface of the terrace 20 connected to the folding lines L are formed at upper portions of the lower props 210a and 210b.

In this case, edge portions of the lower prop tips 212a and 212b are rounded to prevent scratches, etc. from occurring when contacting the terrace 20, the folding lines L, and the shark fins 18, and edges formed when upper surfaces of the lower prop tips 212a and 212b, and rear surfaces of the lower prop tips 212a and 212b facing the process progress path D meet are in contact with boundary lines formed by the folding lines L and the lower surface of the terrace 20.

The lower prop tips 212a and 212b of the lower props 210a and 210b are guided to a folding location in an X-axis direction jointly with the upper props 220a and 220b and the folding bars 230a and 230b by actuation of a normal X-axis transfer means upon folding the shark fins 18, and are in contact with the lower surface of the terrace 20 connected to the shark fin 18, and returned in the X-axis direction by the actuation of the X-axis transfer means described above jointly with the upper props 220a and 220b, and the folding bars 230a and 230b upon completing folding of the shark fins 18.

In the accompanying drawing, a normal pneumatic cylinder is illustrated as the X-axis transfer means, but anyone will be able to see that the X-axis transfer means is not limited to the pneumatic cylinder.

The upper props 220a and 220b are in contact with the upper surface of the terrace 20 connected to the shark fins 18, preferably the upper surface of the terrace 20 connected to the folding lines L, to grip the terrace 20 so as not to interfere with the folding line L jointly with the lower props 210a and 210b.

The upper props 220a and 220b are provided as a pair to face the shark fins 18 formed on the front and rear ends of the 3-sided sealing pouch type secondary battery 10, respectively, similarly to the lower props 210a and 210b.

The upper props 220a and 220b are provided in an approximately vertical plate shape extending along the longitudinal direction of the folding line L, and upper prop tips 222a and 222b contacting a boundary line formed by the upper surface of the terrace 20 connected to the folding lines L are formed at lower portions of the upper props 220a and 220b.

In this case, edge portions of the upper prop tips 222a and 222b are rounded to prevent scratches, etc. from occurring when contacting the terrace 20, the folding lines L, and the shark fins 18, and edges formed when upper surfaces of the upper prop tips 222a and 222b, and rear surfaces of the upper prop tips 222a and 222b facing the process progress path D meet are in contact with boundary lines formed by the folding lines L and the upper surface of the terrace 20.

The upper props 220a and 220b are guided to folding locations in the X-axis direction jointly with the lower props 210a and 210b and the folding bars 230a and 230b by the actuation of the X-axis transfer means described above upon folding the shark fins 18, the upper prop tips 222a and 222b of the upper props 220a and 220b are moved down in a Z-axis direction by actuation of a normal Z-axis transfer means and are in contact with the upper surface of the terrace 20 connected to the shark fin 18, and the upper props 220a and 220b are moved up in the Z-axis direction by the actuation of the Z-axis transfer means described above upon completing the folding of the shark fins 18, and then returned in the X-axis direction by the actuation of the X-axis transfer means described above jointly with the lower props 210a and 210b and the folding bars 230a and 230b.

In the accompanying drawing, the normal pneumatic cylinder is illustrated as the Z-axis transfer means, but anyone will be able to see that the Z-axis transfer means is not limited to the pneumatic cylinder.

The folding bars 230a and 230b fold the shark fins 18 exposed to the outside of the terrace 20 gripped by the lower props 210a and 210b, and the upper props 220a and 220b.

The folding bars 230a and 230b are provided as a pair to face the shark fins 18 formed on the front and rear ends of the 3-sided sealing pouch type secondary battery 10, respectively, similarly to the lower props 210a and 210b, and the upper props 220a and 220b.

The folding bars 230a and 230b are disposed on the rear surfaces of the lower props 210a and 210b, respectively, and the folding bars 230a and 230b are provided in a hexahedral block shape having a length corresponding to lengths of the shark fins 18.

In this case, front surfaces of the folding bars 230a and 230b facing the rear surfaces of the lower props 210a and 210b are formed as inclination surfaces 232a and 232b extended to be inclined downward toward the rear surfaces of the lower props 210a and 210b at the upper portions of the folding bars 230a and 230b, and the inclination surfaces 232a and 232b of the folding bars 230a and 230b, and the lower surfaces of the folding bars 230a and 230b are connected to a gently curved convex curvature surfaces 234a and 234b.

In addition, normal heating elements 236a and 236b are installed inside the folding bars 230a and 230b, which heat the folding bars 220a and 220b to maintain a temperature of approximately 200° C. upon folding the shark fins 18.

The folding bars 230a and 230b are guided to the folding locations in the X-axis direction by the actuation of the X-axis transfer means described above jointly with the lower props 210a and 210b and the upper props 220a and 220b upon folding the shark fins 18, and the folding bars 230a and 230b are moved up in the Z-axis direction by the actuation of another normal Z-axis transfer means to fold the shark fins 18 upwards based on the folding lines L in the terrace 20 supported by the lower props 210a and 210b and the upper props 220a and 220b, and the folding bars 230a and 230b are moved down in the Z-axis direction by the actuation of yet another Z-axis transfer means described above upon completing folding of the shark fins 18, and then returned in the X-axis direction by the actuation of the X-axis transfer means described above jointly with the lower props 210a and 210b and the upper props 220a and 220b.

That is, the inclination surfaces 232a and 232b of the folding bars 230a and 230b push up the shark fins 18 upwards while gradually being in contact with all of the shark fins 18 by contacting ends of the shark fins 18, and the curvature surfaces 234a and 234b of the folding bars 230a and 230b make the shark fins 18 which are pushed upwards be in contact with the upper props 220a and 220b to fold the shark fin 18.

In addition, the folding bars 230a and 230b heated by the heating elements 236a and 236b transfer heat to the adhesive layer of the shark fins 18 when the shark fins 18 are folded to melt the adhesive layer, and the melted adhesive layer flows to a part where electrical insulation is broken while being pressed by the curvature surfaces 234a and 234b of the folding bars 230a and 230b, and the upper props 220a and 220b, thereby restoring an insulating layer where the electrical insulation is broken.

Here, the inclination surfaces 232a and 232b allow the heat of the heating elements 236a and 236b to be transferred from the ends of the shark fins 18 to the folding line L side when the shark fins 18 are folded, whereby the entirety of the adhesive layer of the shark fins 18 is allowed to be melted within a short period of time.

In the accompanying drawing, another Z-axis transport means may be a normal thermo motor and ball screw assembly.

More specifically, the folding bars 230a and 230b fold the shark fins 18 while moving up in the Z-axis direction below the shark fins 18, and the inclination surfaces 232a and 232b provided on the folding bars 230a and 230b are first in contact with the ends of the shark fins 18, and while the folding bars 230a and 230b move up in the Z-axis direction, contact areas of the shark fins 18 and the inclination surfaces 232a and 232b are expanded, and last, the folding line L is contacted, and the curvature surfaces 234a and 234b of the folding bars 230a and 230b press the folding line L to perform folding.

Accordingly, it is possible to ensure sufficient contact time between the shark fins 18 and the folding bars 230a and 230b before the folding bars 230a and 230b press the folding line L to perform folding.

This means that sufficient time is secured to transfer heat from the folding bars 230a and 230b to the shark fins 18, and when the folding bars 230a and 230b press the folding line L, the folding line L portion is sufficiently softened by heat to prevent the folded shark fin 18 from unfolding due to a spring back effect. Ultimately, a folding quality is enhanced.

The following briefly describes an operating state of the shark fin forming device 200 of the 3-sided sealing pouch type secondary battery formed as described above.

In a folding line forming process S1, when the 3-sided sealing pouch type secondary battery 10 with the folding lines L formed on the front and rear ends is mounted on a cell transfer shuttle and guided to a folding location, the heating elements 236a and 236b are actuated to heat the folding bars 230a and 230b.

Then, the X-axis transfer means is actuated to move the lower props 210a and 210b, the upper props 220a and 220b, and the folding bars 230a and 230b to the folding location.

In this case, when the lower props 210a and 210b, the upper props 220a and 220b, and the folding bars 230a and 230b are moved to the folding location, the lower prop tips 212a and 212b of the lower props 210a and 210b are in contact with a boundary line formed by the lower surface of the terrace 20 connected to the shark fin 18, and the folding line L.

When the lower prop tips 212a and 212b of the lower props 210a and 210b are in contact with the boundary line formed by the lower surface of the terrace 20 and the folding line L, the Z-axis transfer means is actuated to make the upper prop tips 222a and 222b of the upper props 220a and 220b be in contact with the boundary line formed by the upper surface of the terrace 20 connected to the shark fins 18, and the folding line L.

When the terrace 20 with the shark fins 18 is gripped by the lower props 210a and 210b and the upper props 220a and 220b, another Z-axis transfer means is actuated to move up the folding bars 230a and 230b, and in this case, the inclination surfaces 232a and 232b of the folding bars 230a and 230b which are moved up push up the shark fins 18 upwards while gradually being in contact with all of the shark fins 18 by contacting ends of the shark fins 18, and the curvature surfaces 234a and 234b of the folding bars 230a and 230b make the shark fins 18 which are pushed upwards be in contact with the upper props 220a and 220b to fold the shark fins 18.

In addition, at the same time, the folding bars 230a and 230b transfer heat to the adhesive layer of the shark fins 18 to melt the adhesive layer, and in this case, the melted adhesive layer flows to a part where electrical insulation is broken while being pressed by the curvature surfaces 234a and 234b of the folding bars 230a and 230b, and the upper props 220a and 220b, thereby restoring an insulating layer where the electrical insulation is broken in the shark fin 18.

Meanwhile, when the folding of the shark fins 18 is completed as described above, the Z-axis transfer means and another Z-axis transfer means are actuated to return the upper props 220a and 220b and the folding bars 230a and 230b, respectively, and at the same time, the X-axis transfer means is actuated to return the lower props 210a and 210b, the upper props 220a and 220b, and the folding bars 230a and 230b.

The shark fin forming device 200 of the 3-sided sealing pouch type secondary battery 10 according to the present invention formed as such may easily fold the shark fins 18 based on the folding line L formed at the shark fins 18 of the 3-sided sealing pouch type secondary battery 10.

According to the present invention, since the shark fin 18 is folded by assigning heat and pressure upon folding the shark fin 18, the adhesive layer of the shark fin 18 may be melted and flow to a portion where electrical insulation is broken, and as a result, the electrical insulation for the adhesive layer of the shark fin 18 may be ensured.

What is claimed is:

1. A device for forming a shark fin of a 3-sided sealing pouch type secondary battery, the device comprising:
lower props being in contact with a lower surface of a terrace connected to the shark fins formed at a front end and a rear end of a sealed surface of the 3-sided sealing pouch type secondary battery;
upper props being in contact with an upper surface of the terrace connected to the shark fins; and
folding bars folding the shark fins exposed to the outside of the terrace gripped by the lower prop and the upper prop,
wherein heating elements are installed inside the folding bars,
the folding bars fold the shark fins upwards while moving up below the shark fins, and
front surfaces of the folding bars contacting the shark fins are formed as inclination surfaces extended to be inclined downwards to a rear surface of the lower prop from upper surfaces of the folding bars, and the inclination surface and the lower surface of the folding bar are connected to convex curvature surfaces.

2. The device for forming a shark fin of a 3-sided sealing pouch type secondary battery of claim 1, wherein a folding line is provided, which is aligned with the sealed surface, and formed up to an adjacent location of the sealed surface from ends of the both terraces facing both ends of the sealed surface,
the upper props are extended in a longitudinal direction of the folding line so as to be parallel to the sealed surface,
upper prop tips contacting the upper surfaces of the terrace connected to the folding lines are formed at lower portions of the upper props,
the lower props are extended in the longitudinal direction of the folding line so as to be parallel to the sealed surface, and
lower prop tips contacting the lower surfaces of the terrace connected to the folding lines are formed at upper portions of the lower props.

3. The device for forming a shark fin of a 3-sided sealing pouch type secondary battery of claim 2, wherein an edge portion of the lower prop tip is formed as a curvature surface, and
an edge formed when an upper surface of the lower prop tip and a rear surface of the lower prop tip meet is in contact with a boundary line formed by the folding lines and the lower surface of the terrace, and
an edge portion of the upper prop tip is formed as the curvature surface, and
an edge formed when a lower surface of the upper prop tip and a rear surface of the upper prop tip meet is in contact with a boundary line formed by the folding lines and the upper surface of the terrace.

4. The device for forming a shark fin of a 3-sided sealing pouch type secondary battery of claim 3, wherein the lower props are guided to a folding location jointly with the upper props and the folding bars by actuation of an X-axis transfer means, and are in contact with the lower surface of the terrace connected to the shark fins, and returned by the actuation of the X-axis transfer means jointly with the upper props and the folding bars upon completing folding of the shark fins, and
the upper props are guided to a folding location jointly with the lower props and the folding bars by the actuation of the X-axis transfer means, and moved down by actuation of a Z-axis transfer means and are in contact with the upper surface of the terrace connected to the shark fins, and moved up by the actuation of the Z-axis transfer means upon completing the folding of the shark fins, and returned by the actuation of the X-axis transfer means jointly with the lower props and the folding bars.

5. The device for forming a shark fin of a 3-sided sealing pouch type secondary battery of claim 2, wherein the folding bars are disposed on the rear surfaces of the lower props, and the folding bars have a length corresponding to lengths of the shark fins.

6. The device for forming a shark fin of a 3-sided sealing pouch type secondary battery of claim 5, wherein the folding bars are guided to a folding location jointly with the lower props and the upper props by actuation of an X-axis transfer means, and fold the shark fins upwards based on the folding lines while being moved up by actuation of another Z-axis transfer means, and moved down by the actuation of the another Z-axis transfer means and at the same time, returned by the actuation of the X-axis transfer means jointly with the lower props and the upper props.
